(19) United States
(12) Patent Application Publication
(10) Pub. No.: US 2025/0342391 A1
(43) Pub. Date: Nov. 6, 2025

(54) SYSTEMS AND METHODS TO STACK MACHINE LEARNING MODELS TO CAPTURE DETERMINISTIC RELATIONS

(71) Applicant: SAP SE, Walldorf (DE)

(72) Inventors: Tim Breitenbach, Oberleichtersbach (DE); Saleh GHOLAM ZADEH, Heidelberg (DE)

(21) Appl. No.: 18/653,714

(22) Filed: May 2, 2024

(51) Int. Cl. G06N 20/00

(52) U.S. Cl. CPC G06N 20/00

(57) ABSTRACT

Described herein are techniques for stacking machine learning models to better capture deterministic relations in a dataset. In some instances, a first machine learning model may not be capable of capturing all of the deterministic relations in a dataset due to the limitations of the model. Supplemental models may be trained so that the corrections generated by the supplemental models, when combined with the first machine learning model, perform better at capturing the deterministic models in the dataset. Techniques are described for training supplemental models to capture deterministic relations associated with ordinal data and nominal data and continuous data.

### BACKGROUND

Unless otherwise indicated herein, the approaches described in this section are not prior art to the claims in this application and are not admitted to be prior art by inclusion in this section.

Machine learning (ML) models are programs that can analyze unseen data to find patterns or make decisions. In order to do so, the ML model is first trained with a training dataset. A common procedure used for training and evaluating ML models is to define a loss function that defines how close output variables generated from the ML model are to the training data. The training data is also known as ground truth. In real world scenarios, it may be difficult for the ML model to achieve the best possible loss function value due to the presence of noise. Since training a ML model is both time and resource intensive, there is a need to automatically determine whether the presence of errors in the ML model according to the loss function value is due to noise or because the trained ML model has missed additional information it can learn from the training data. Sometimes due to the limitations of a ML model, it may be difficult for a single ML model to capture all of the deterministic relations in the dataset.

### BRIEF DESCRIPTION OF THE DRAWINGS

FIG. 1 illustrates a system for training a ML model according to some embodiments.

FIG. 2 illustrates the model training block according to some embodiments.

FIG. 3 illustrates an exemplary implementation of a trained ML model analyzer according to some embodiments.

FIG. 4 illustrates an exemplary workflow for training a ML model according to some embodiments.

FIG. 5 illustrates a ML model stacker for processing ordinal data according to some embodiments.

FIG. 6 illustrates a ML model stacker for processing nominal data according to some embodiments.

FIG. 7 illustrates an exemplary workflow for training a ML model according to some embodiments.

FIG. 8 depicts a simplified block diagram of an example computer system, which can be used to implement some of the techniques described in the foregoing disclosure.

### DETAILED DESCRIPTION

Described herein are methods and apparatuses to train a ML model. The performance of a ML model depends on the training and the training may be evaluated by defining a loss function or accuracy score. The loss function defines how close the ML model's output variables are to the ground truth. For example, training data may store a set of entries where each entry includes one or more input variables and one or more output variables. The output variables are the result that is expected when the input variables are fed into the ML model. In other words, the output variables in the training dataset represent the ground truth. While training dataset is mentioned here, any dataset that is provided for purposes of training or testing the ML model (such as testing dataset, validation dataset, etc.) can be considered the ground truth of the ML model.

Unfortunately, measuring performance of the ML model with a loss function is less accurate when there is inherent noise in the system which affects the output generated by the ML model. For example in a cloud environment where the ML model is to allocate compute resources, the compute resources may have random utilization which is not predictable and learnable by the ML model. Since the noise is random and affects the output variables generated by the ML model, the accuracy scores calculated from the loss function may be less accurate due to the noise. Therefore it is important to differentiate low accuracy scores due to a high amplitude of noise versus low accuracy scores due to the ML model missing predictable relations. Described herein is a technique to measure the performance of the ML model based on the deterministic relations rather than the loss function or accuracy score. A deterministic relation is defined as stochastic dependency between the input and the output of the ML model. If an input variable is stochastically dependent on an output variable, then a deterministic relation is present. An example of a deterministic relationship is the weight relationship between the pounds and kilograms or the conversion relationship between temperature in degrees Celsius and Fahrenheit.

In some embodiments, ML model training includes analyzing a trained first ML model to determine whether the trained first ML model has captured all of the deterministic relations within the training dataset. If the ML model has captured all of the deterministic relationships within the training dataset, then the ML model has learned all it can from the training dataset. By evaluating performance of the trained first ML model based on deterministic relationships rather than loss function or accuracy score, we can determine whether the trained first ML model has learned all there is to learn from the training dataset. In some embodiments if the trained ML model has not captured all of the deterministic relations in the training dataset (meaning that there are additional deterministic relations yet to be captured), then a second ML model can be introduced and trained using the same input variables as the first ML model. The deviations generated from the trained first ML model can be used as the ground truth for the second ML model. Once the second ML model has been trained, the second ML model can be stacked on the first ML model. Stacking means that the output from the first and second ML model would be added together and the two ML models would receive the same input. In some examples, the output of the second ML model is called corrections. Performance of the stacked ML models can be measured by whether the stacked ML model has done a better job capturing the deterministic relations than the first ML model. In one embodiment, performance is measured by subtracting the ground truth from the output of the stacked ML model (e.g., output from the first model plus the correction from the second model). The result is known as the deviation. In some embodiments, stochastic independence or mutual information between the input variables and the deviation is determined. If there is dependence between the input variables and the deviation, then that means that there are additional deterministic relations to be captured. If the stacked ML model has captured more deterministic relations than the first ML model, then the stacked ML model performs better than the first ML model by itself and the final ML model should include the second ML model stacked onto the first ML model. This process of stacking additional ML models can be repeated until all of the deterministic relations are captured. In one embodiment, the selection of the second ML model may be a manual process where an AI architect provides the second ML model. In another embodiment, the selection of the second ML model may be an automated process where different ML models are systematically tested to see if the output of the stacked ML model (also known as the correction), when second model is added to the output of the first ML model, is able to capture more deterministic relations than the first ML model can capture by itself. If more deterministic relations are captured than the first ML model by itself, then the second ML model will be included in the final ML model. Otherwise, the second ML model is discarded and third ML model is tested stacked on top of the first ML model. As mentioned above, the third ML model may be configured by an AI architect or automatically through an automated process. This process may be repeated until we have stacked models up to a predefined number or have extracted all the deterministic information from the data.

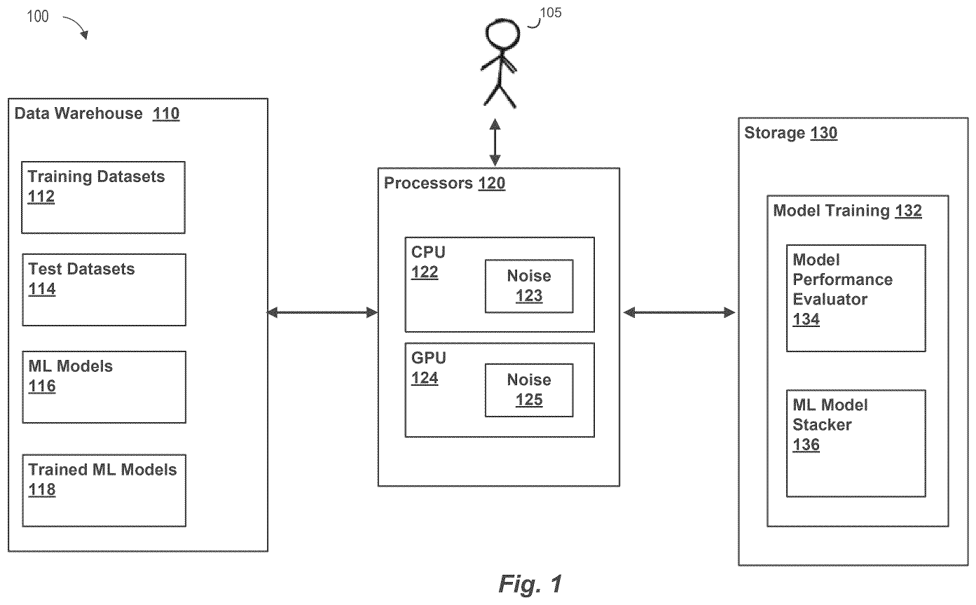

FIG. 1 illustrates a system for training a ML model according to some embodiments. System 100 includes user 105, data warehouse 110, processors 120, and storage 130. Processors 120, which include CPU 122 and GPU 124 are configured to process computer readable instructions from storage 130 to process data and ML models from data warehouse 110. As shown here, CPU 122 may experience noise 123 that is random and non-deterministic. Similarly, GPU 124 may experience noise 125 that is also random and non-deterministic. Noise 123 and 125 may have a negative effect to the training of ML models since the noise affects the output of the ML models so therefore, solutions for training ML models that can negate the noise are advantageous.

Data warehouse 110 includes training datasets 112, test datasets 114, ML models 116, and trained ML models 118. Training datasets 112 include datasets which are utilized during training of ML models. Similarly, test datasets 114 include datasets which are utilized during testing of ML models. Each dataset may contain a plurality of entries used for training (or testing) the ML models. Each entry within a dataset includes input variables and output variables. The input variables are input into a ML model and the output variables are the desired output from the ML model. The output variables are known as ground truth. In some embodiments, a training dataset may be used in training the ML model and the testing dataset is used to test the trained ML model to determine whether the trained ML model is able to accurately predict the ground truth. If the ML model performs poorly on the test dataset, then the ML model may be retrained. Retraining can include selecting another ML model architecture, changing the hyperparameters of the ML model, and changing the loss function, to name a few. ML models 116 may store ML models that can be selected as a ML architecture to use when training a ML model with a training dataset. Trained ML models can be stored in trained ML models 118.

Storage 130 stores computer readable instructions which, when executed by one or more processors in processors 120, can train a ML model. The computer readable instructions can include model training 132 which trains a ML model and model training 132 can include model performance evaluator 134 and ML model stacker 136. Each component shown here can be a block of software code which can be executed by CPU 122 or GPU 124. In one embodiment, model performance evaluator can contain computer code to determine whether the training dataset includes input/output variables that have deterministic relations. In another embodiment, model performance evaluator 134 can determine whether a trained ML model has captured all of the deterministic relations in the input/output variables of the training dataset. If the trained ML model has captured all the deterministic relations in the training dataset, then training can conclude. In contrast if the trained ML model has not captured all of the deterministic relations, then the trained ML model can be further modified to learn the deterministic relations not yet captured. In some embodiments, model training 132 may measure the stochastic dependence or mutual information between the input data and deviations to determine whether all deterministic relations have been captured. For example a measurement of mutual information that returns zero or close to zero would imply that all or close to all of the deterministic relations have been captured in the model.

In some instances, training can no longer improve the ML model and there are still deterministic relations in the training dataset to be captured. The deterministic relations are calculated in two steps. In the first step, the difference between the output from the ML model and the ground truth is calculated. The difference is also known as the deviation. In the second step, stochastic dependence is measured between the input values in the training dataset and the deviations. If there is dependence, then there are still deterministic relations to be captured. Alternatively, if there is no dependence, then all the deterministic relations have been captured by the ML model. In one embodiment, ML model stacker 134 may generate a stacked ML model, where the stacked ML model includes the trained ML model that has not captured all of the deterministic relations in the training dataset, plus a second trained ML model. Adding a second trained ML model may be advantageous since a second trained ML model may be able to capture different deterministic relations than the first ML model. For example, it is difficult for a ML model to focus on both long term and short term predictions at the same time. Also one loss function can be optimized for one type of noise so by having two different loss functions, it is possible to optimize for more than one type of noise.

Here, user 105 may provide instructions to processor 120 train a ML model. In one example, user 105 may define the ML model to use, the training dataset to use, and configure the ML model. Processor 120 may retrieve computer readable instructions from storage 130 to train the ML model, which can include model training 132. Processor 120 may also retrieve the desired training dataset and ML model from data warehouse 110 and execute computer readable code from storage 130 to train the ML model. In some examples where trained ML model has not captured all of the deterministic relations in the training dataset, model training 132 may query user 105 to provide a second ML model. User 105 may define the second ML model to use and configure the second ML model to be trained with the same training dataset. Model training 132 may return a stacked ML model that includes the first ML model and the second ML model, where the stacked ML model captures more deterministic relations in the training dataset than the first ML model alone.

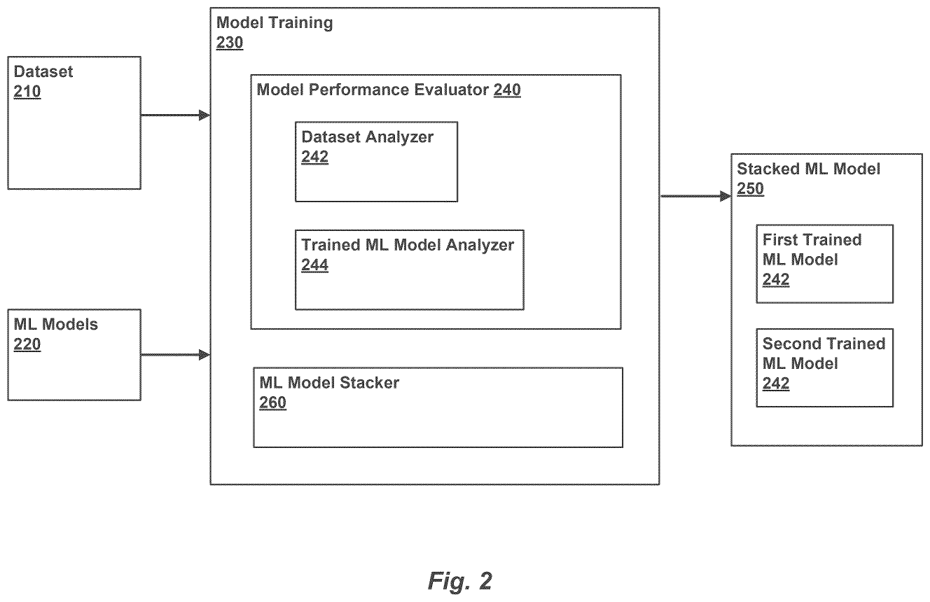

FIG. 2 illustrates the model training block according to some embodiments. Each block in model training 230 represents a piece of software code configured to perform a task to train a ML model 220 with the use of dataset 210. Dataset 210 can be a training dataset, test dataset, validation dataset, or other dataset. The output of model training 230 is stacked ML model 250. Stacked ML model includes a plurality of trained ML models that are stacked on top of one another. Stacking ML models is defined as applying the same input to the ML models and summing the outputs of the ML models together. For example if we apply the same input to a first and second ML model and the first ML model has a first output variable with a value of 2 and the second ML model has a first output variable with a value of 4, then the sum of the first output variable would be a value 6. Model training block 230 includes model performance evaluator block 240. Model performance evaluator block 240 is configured to evaluate the dataset for deterministic relations and to determine whether a trained ML model can further learn additional deterministic relations from the dataset. Model performance evaluator 240 includes dataset analyzer 242 and trained ML model analyzer 244. Dataset analyzer 242 is configured to analyze a dataset to determine whether there is stochastic dependence between the output variables and the input variables. Dependence may be defined as the opposite of independence, meaning that inputs and outputs take their values independent of each other. If there is dependence, then there are deterministic patterns that relate the input variables and the output variables of the dataset. These are also known as deterministic relations. With these deterministic relations, it is possible to predict the output from a given input and therefore, the dataset can be used to train a ML model. In contrast if there are no deterministic relations, then the input variables cannot be used to predict the output variables and therefore, a ML model would not be suitable. In one embodiment, dataset analyzer 242 performs a pairwise analysis in which it determines if there is dependence between an input variable and an output variable pair. This analysis can be performed for every combination of input and output variables to identify which pairs are dependent or in general which sets of output variables depend on which sets of input variables. In another embodiment, dataset analyzer analyzes each output variable to determine whether the output variable is dependent on one or more input variables. In this scenario, there can be a 1:many mapping between output variables and input variables. In general, dataset analyzer 242 is trying to determine if there is a relationship between the output the ML model is to predict and the input of the ML model. In some embodiments, dataset analyzer 242 determines simply whether there is a deterministic relationship between the input and output variables without specifying which output variables have a relationship with which input variables. This general conclusion may require less compute resources to determine and therefore is more efficient.

Determining whether the dataset has deterministic relations can be performed in numerous ways. In one embodiment, dataset analyzer 242 can determine whether the output and the input share mutual information. In one example, a mutual information value can be calculated that represents whether the output variables and the input variables of the dataset are dependent. In another embodiment, dataset analyzer 242 can determine whether the output and the input are stochastically independent. Stochastically independence means that the input variables do not affect output variables with respect to their taken values, and vice versa. In one embodiment, a stochastic independence value can be calculated that represents whether the output variables and input variables of the dataset are stochastically independent. In yet another embodiment, a Pearson correlation coefficient can be calculated between the input and output variables of the dataset that represents whether the input variables and output variables are correlated.

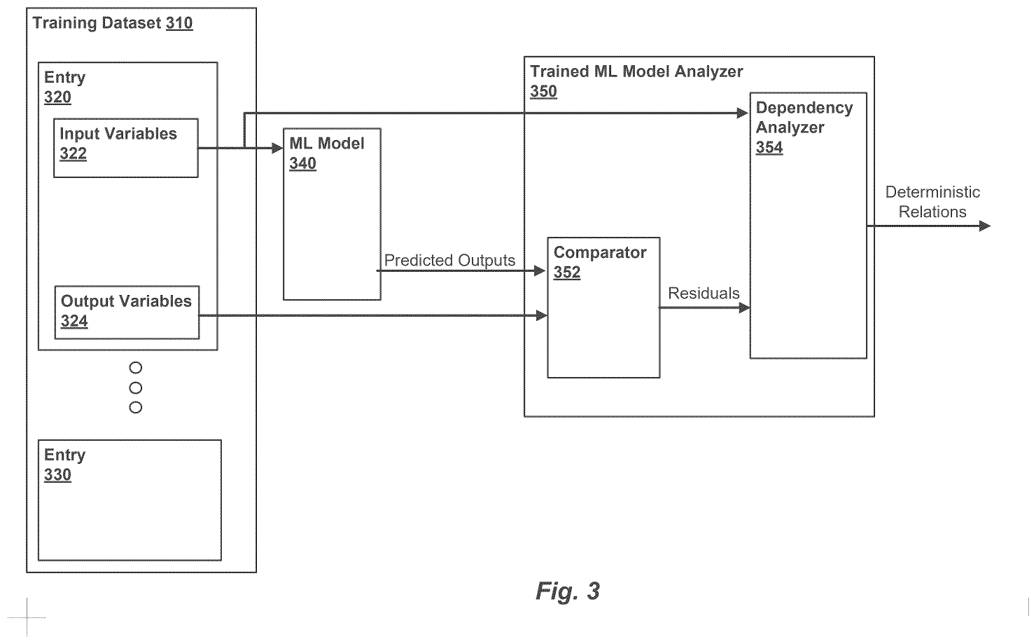

Trained ML model analyzer 244 is configured to analyze a trained ML model to determine whether the trained ML model has learned or captured all the deterministic relations in the dataset. If all the deterministic relations in the dataset have been captured in the trained ML model, then the trained ML model has been optimized and model training can conclude. On the other hand, if not all the deterministic relations in the dataset have been captured by the trained ML model, then the trained ML model can be further improved. In one embodiment, model training 230 may retrain the trained ML model when not all deterministic relations in the dataset have been captured by the trained ML model. Retraining can include selecting a different ML architecture for the ML model. Retraining can also include hyperparameter tuning to fine tune the ML model. Retraining can also include modification of the loss function. Details on how the trained ML model analyzer analyzes the trained ML model and the dataset to determine whether the trained ML model has captured all of the deterministic relations in the dataset are described below in FIG. 3.

Model training further includes ML model stacker 260 which is configured to train and stack a second ML model on a first trained ML model to generate a stacked ML model. In one embodiment, the selection of the second ML model may be automated by having ML model stacker 260 systemically trying different ML models until a ML model achieves the desired effect. The desired effect may be that the stacked ML model is able to capture more deterministic relations than the first ML model alone. For example, ML model stacker may try different ML models by adjusting the architecture, hyperparameter tuning, loss function, and activation functions of the ML model. In another embodiment, a user such as an AI architect may select a ML model to try as the second ML model. The AI architect may review the first ML model and select a second ML model that they believe would complement the first ML model in capturing deterministic relations. Selecting the second ML model may include selecting the architecture, hyperparameter tuning, loss function, and activation function of the ML model. In one example, the AI architect may select the second ML model by copying the first ML model and adjusting the parameters. ML model stacker 260 is configured to run the training dataset on the stacked ML model to determine whether the stacked ML model performs better than the first ML model alone. In one embodiment, performance is measured based on whether the stacked ML model captures more deterministic relations than the first ML model alone. In some implementations it may be difficult to count the number of deterministic relations. Therefore, ML model stacker may be configured to measure the stochastic dependence or mutual information between the input and the model deviation from ground truth (a.k.a. the deviations) instead of counting the deterministic relations. If the stochastic dependence or mutual information is lower in the stacked ML model than the first ML model alone, then the stacked ML model performs better than the first ML model alone. In another embodiment, performance is measured based on whether the stacked ML model is able to capture at least one deterministic relation not yet captured by the first ML model.

FIG. 3 illustrates an exemplary implementation of a trained ML model analyzer according to some embodiments. As described above, the trained ML model analyzer can analyze the deterministic relations that the trained ML model has captured in the training dataset. The analysis can include determining whether there are deterministic relations in the training dataset that are not captured by the trained ML model. As shown in FIG. 3, trained ML model analyzer 350 receives training dataset 310 as an input. Training dataset 310 includes a plurality of entries, each entry including input variables and output variables. Here, entry 320 is being processed by trained ML model analyzer 350 and entry 330 shall be processed later. The input variables from training dataset 310 are provided as input into trained ML model 340 to generate predicted outputs. Each predicted output may correspond to an output variable of training dataset 310. In other words, there is a 1:1 mapping between the output variables and the predicted outputs. If the training dataset has two output variables (e.g., A, B), then the trained ML model also generates two predicted outputs (e.g., X, Y) and there would be a 1:1 mapping between them (X corresponds to A, Y corresponds to B). As shown here, entry 320 is being analyzed by the trained ML model analyzer. Input variables 322 from entry 320 are provided as input to trained ML model 340 to generate predicted outputs. The predicted outputs and the output variables 324 from entry A 320 are then provided as inputs to comparator 352. In some embodiments, the data type of a predicted output generated is the same as the data type as its corresponding output variable. For example, the data type of predicted output X is the same data type as output variable A.

Comparator 352 is configured to compare the predicted outputs with the output variables to determine the correctness of the prediction generated by the trained ML model. The comparator 352 may generate a random variable \ for each comparison performed where the random variable defines the deviation of the predicted output from the ground truth (i.e., output variable). If there are three predicted outputs and three output variables, then comparator 352 would perform three comparisons and generate three random variables. In one example, the random variables may be residuals or deviations.

In some embodiments, the way in which comparator 352 generates the random variable may depend on the data type of the output variable. When the data type of the output variable is ordinal data, continuous data, or discretized data, comparator 352 may calculate the random variable as the difference between the output variable and the predicted output. For example if the output variable is the number 5.8 and the predicted output is 7.2, then the comparator can generate a random variable with a value that's the difference between 5.8 and 7.2, which is −1.4. In some embodiments, comparator 352 may generate the random variable such that the random variable outputs an absolute value so in the example above, the random variable's output would be simply 1.4. When the data type of the output variable is nominal data, comparator 352 may set the random variable to a predetermined value when the predicted output is correct and to a different value when the predicted output is incorrect. For example, comparator 352 may set the random variable to 1 when the predicted output is correct and set the random variable to 0 when the predicted output is incorrect.

In a different embodiment when the output variable is nominal data, comparator 352 may set the random variable to the correct value when the predicted output is incorrect and set the random variable to 0 or −1 when the predicted output is correct. For example, let's assume the output variable is nominal data type that is the days of the work week so the output variable could be set as Monday, Tuesday, Wednesday, Thursday, or Friday. Each of the possible outcomes can be assigned a number (Monday=1, Tuesday=2, Wednesday=3, Thursday=4, Friday=5). Let's assume the output variable is Wednesday however the predicted output is Monday. In this scenario, comparator 352 sets the random variable to the value 3 since Wednesday is the ground truth. Similarly, if the output variable is Tuesday and the predicted output is also Tuesday, then the comparator 352 sets the random variable to the value 0 since the predicted output is correct.

Alternatively, a multi-dimensional approach could be chosen where the random variable models the difference between the actual distribution of the classes (e.g., 1 for the correct class, 0 otherwise) given the input and the distribution predicted by the model for the given input. If these random variables contain information with the input, there are still learnable relations that can be learned by other models to correct the prediction of the below stack by correcting the predicted distribution. In the case, where the random variable is the difference of distributions, we get from the model on top of the current stack the correction that we have to add to the distribution from the stack below such that, e.g., the max of the sum (defined component wise over the classes) of the distribution from the stack and the correction is the correct class. This addition and choice of the class would be done in the decision module.

After the comparator has processed all entries, each entry in the training dataset is associated with a set of residuals that were generated by the comparator, where a residual was generated for each comparison performed (comparing a predicted output of the entry with the ground truth). Similarly, training dataset 310 also has input variables for each entry in the training dataset 310 so there is a 1:1 mapping between the input variables and the set of residuals for a given entry. And each residual is related to a corresponding output variable from the training dataset (i.e. ground truth) as described above.

As mentioned above, the generated residuals represent the correctness of the prediction of the ML model against the ground truth. If the prediction is correct, the residual value is zero. Dependency analyzer 354 receives the input variables along with the generated residuals and determines whether there is a dependence between the input variables and the generated residuals. If there is no dependence, then trained ML model has captured all of the deterministic relations in the training dataset 310 and dependency analyzer 354 can output a result that there is no dependence (i.e., no deterministic relations output). In contrast if there is dependence, then this means that the trained ML model has not captured all of the deterministic relations in the training dataset 310. Therefore, dependency analyzer 354 may identify in the output the residuals that are still dependent on the input variables. By identifying the residuals that are still dependent, the system is able to identify the input variables that correspond to the dependent residuals as input variables that can be further trained in the trained ML model. In some embodiments, the training dataset and the validation dataset can be utilized to determine whether all the deterministic relationships have been captured in the trained ML model. If they haven't all been captured, then the system can retrain the trained ML model. This retraining can include hyperparameter tuning, changing the loss function, or modifying the ML architecture, to name a few. Below is an example table illustrating three entries in the training dataset as rows, the ground truth for the output variables, the predicted output generated by the trained ML model, and also the generated residuals.

| Input | Ground | Ground | Prediction | Prediction | Residual | Residual |
|---|---|---|---|---|---|---|
| Variables | Truth A | Truth B | X | Y | X-A | Y-B |
| Input 1 | 5 | 3 | 5.5 | 1 | −0.5 | 2 |
| Input 2 | 2 | 4 | 1 | 4 | 1 | 0 |
| Input 3 | 7 | 8 | 5 | 9 | 2 | −1 |

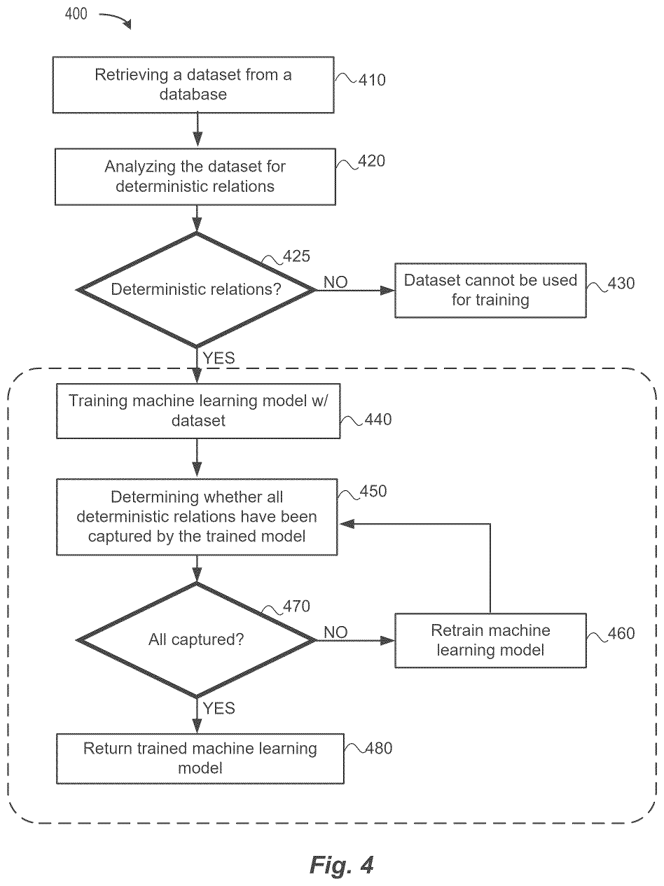

FIG. 4 illustrates an exemplary workflow for training a ML model according to some embodiments. Workflow 400 can be implemented as computer readable code that is stored in model training 230 of FIG. 2 and model performance evaluator 240 of FIG. 2, the code being executable by one or more processors from processors 120 of FIG. 1. Workflow 400 can begin by retrieving a dataset from a database at 410. In one example, the database is data warehouse 110 of FIG. 1. Depending on the implementation, the dataset can be any dataset that the user plans on using to train a ML model. Workflow 400 continues by analyzing the dataset for deterministic relations at step 420. In one embodiment, the analysis may include calculating the mutual information value that represents the correlation between the input and output variables of the dataset. In another embodiment, the analysis may include calculating a stochastic independence value that represents whether the input and output variables are stochastically independent. In yet another embodiment, the analysis may include calculating a Pearson correlation coefficient representing the correlation between the input and output variables.

Workflow 400 then determines whether there are deterministic relations in the dataset based on the analysis at 425. If there aren't deterministic relations, workflow 400 concludes that the dataset cannot be used for training a ML model at step 430. A different dataset may be retrieved and workflow 400 can restart. Alternatively, if there are deterministic relations in the dataset, workflow 400 continues by training the ML model with the dataset at step 440. In one embodiment, the ML model can be trained by modifying the ML model such that when the input variables from an entry of the dataset are input into the ML model, the output of the ML model is close to the output variables from the entry. In other embodiments, other common techniques to train a ML model with the use of a dataset can be applied.

Once the ML model has been trained with the use of the dataset, workflow 400 continues by determining whether all deterministic relations have been captured by the trained machine learning model at step 450. In one embodiment is performed by the trained ML model analyzer 244 of FIG. 2. An example implementation of the trained ML model analyzer is provided in FIG. 3. At step 470, workflow 400 checks whether all the deterministic relations have bene captured by the trained ML model. If all or some of the deterministic relations have not been captured, then workflow 400 continues with retraining the trained ML model at step 460. Retraining can include one or more of hyperparameter tuning, selecting a different loss function, or selecting a different ML architecture. After retraining, workflow 400 determines whether all the deterministic relations have been captured again at 450. This loop may repeat itself until all deterministic relations have been captured. Once all the deterministic relations have been captured, then workflow 400 continues by returning the trained ML model at 480. In some embodiments where it is known that the dataset (training, validation, test, etc.) includes deterministic relations, steps 410-430 can be skipped and workflow 400 can start at step 440 with the training of the ML model as shown in FIG. 4 with the dotted box.

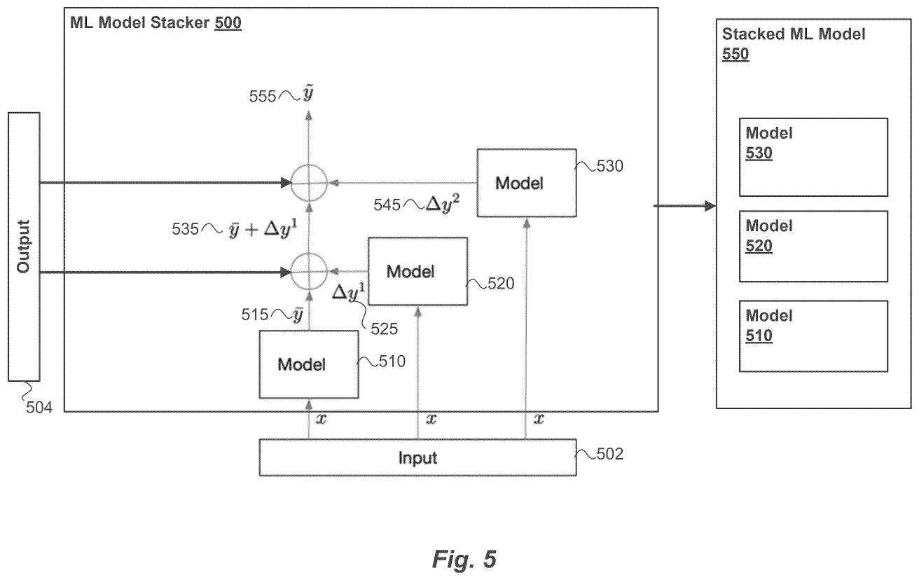

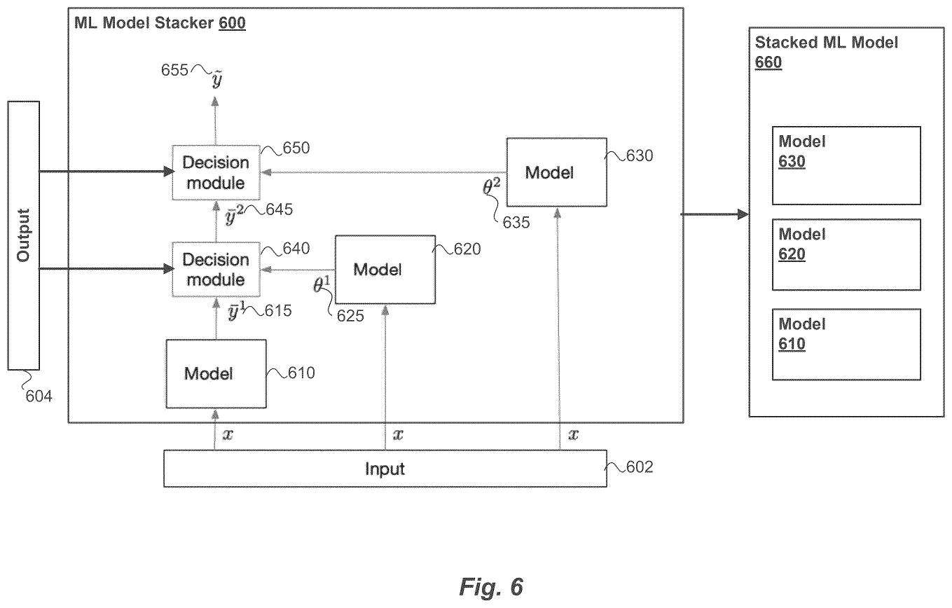

In some embodiments, the technique ML model stacker applies may depend on the data type of the output variable. If the data type of the output variable is ordinal data, continuous data, or discretized data, then one technique is applied. If the data type of the output variable is nominal data, then a different technique is applied. FIGS. 5 and 6 illustrate two different techniques that may be applied depending on the data type of the output variable. In some embodiments, the model training may include two separate functions for ML model stacking where a first function is called for ordinal data and the second function is called for nominal data. The ML model stacker may select a technique depending on the data type of the output functions that the second ML model is targeting. For example if the trained ML model analyzer 244 in FIG. 2 were to measure the stochastic dependence or mutual information and conclude that there is still a deterministic relation not yet captured by the first ML model and that the deterministic relation is related to an output variable that is continuous data, then the ML model stacker 260 of FIG. 2 would apply the technique for continuous data. In some examples, the deterministic relations yet to be captured include both ordinal and nominal data. In one embodiment, the ML model stacker may perform both techniques, meaning that there would be at least two ML models to be added to the stack—at least one additional ML model for each data type. For example if the trained ML model analyzer 244 in FIG. 2 were to conclude that there are two deterministic relations not yet captured by the first ML model and that the first deterministic relation is related to an output variable that is continuous data and that the second deterministic relation is related to an output variable that is nominal data, then the ML model stacker 260 of FIG. 2 may need to generate a ML model for each data type. In another embodiment, the ML model stacker may define corresponding random variables for each data type in a single ML model to be added to the stack.

FIG. 5 illustrates a ML model stacker for processing ordinal data according to some embodiments. As shown, ML model stacker 500 is configured to train additional ML models to capture deterministic relations in model 510. This may be advantageous when it is desirable to capture all of the deterministic relations that are present in the training dataset. When all the deterministic relations have been captured, then the ML model (or models) have learned all there is to learn in the training dataset. The additional ML models (here model 520 and model 530) may be configured manually by a user or alternatively may be automatically selected by ML model stacker through a selection algorithm. Training dataset includes input 502 and output 504. In one example,

The goal of model 520 is to supplement the results of model 510 so that the sum of the output of models 510 and 520 are closer to the ground truth (i.e., output 504). ML model stack 500 may first compare the predicted output 515 from model 510 with the output 504. For ordinal data, the comparison may result in a value generated by subtracting the predicted output 515 from output 504. In some examples, the value is an absolute value. The value generated is the delta between the predicted output of model 510 and the ground truth. This delta value is what ML model stacker 500 would like the output of model 520 to produce and therefore, ML model stacker 500 may train model 520 to produce the delta value. Once model 520 has been trained to output the delta values, ML model stacker 500 may test models 510 and 520 to see whether the combination produces better results than model 510 alone. Testing may include applying input 502 to models 510 and 520 to generate predicted outputs 515 and 525. Predicted outputs 515 and 525 are added together to form predicted output 535. Predicted output 535 is then compared against output 504 to generate residuals. Input 502 is then correlated with the residuals to determine the deterministic relations captured by the stacked ML model of model 510 and model 520. Performance of the stacked ML model may then be examined. If the performance is poor, then ML model stacker 500 may attempt to retrain model 520 by adjusting the model's configuration or selecting a different model all together. If performance is good, then ML model stacker 500 may keep model 520 as part of the stacked ML model. In one example, performance is measured by whether the stacked ML model is able to capture more deterministic relations with the addition of the new ML model. In another example, performance is measured by whether the stacked ML model is able to capture a new deterministic relation with the addition of the new ML model.

This process of stacking new ML models on the stacked ML model can iteratively repeat to keep capturing additional deterministic relations in the training dataset until there are no additional deterministic relations to be captured. Here, the process has been iterated a second time with the addition of model 530. As shown here, model 530 generated predicted output 545, which is added to the predicted output 535. The new predicted output 555 is compared with output 504 to generate new residuals, which in turn are correlated with input 502 to determine whether all deterministic relations have been captured by the stacked ML model of model 510, 520, and 530. Once all deterministic relations have been captured, ML model stacker 500 outputs stacked ML model 550, which includes models 510, 520, and 530.

FIG. 6 illustrates a ML model stacker for processing nominal data according to some embodiments. ML model stacker 600 is configured to train additional ML models to supplement the first ML model so that the combination performs better than the first ML model alone. Here, model 610 is the first ML model and models 620 and 630 are stacked ML models that supplement model 610. The goal is for the first ML model when combined with the supplemental ML model(s) to more accurately predict output that is the ground truth. The predicted output of the supplemental ML models is also known as corrections.

In one embodiment, supplemental ML models may generate a correction that models if the class has been correctly predicted. The supplemental ML model may generate a predicted output (also known as the correction) of value 0 or −1 when currently stacked model (which may be just the base ML model) is correct. The supplemental ML model may also generate a predicted output with a value associated with the correct class when the supplemental ML model predicts that the currently stacked model (which may be just the base ML model) incorrectly predicts the class. In this scenario, decision modules 640 can generate a predicted output based on the predicted output 615 and correction 625. If correction 625 is the value 0, then decision module 640 outputs the value received from prediction output 615 as predicted output 645. Alternatively, if correction 625 is a value other than 0, then decision module 640 outputs the value from correction 625 as predicted output 645. A similar algorithm may apply to decision module 650, which receives predicted output 645 and correction 635. After model 620 has been trained, the performance of the stacked ML model is measured. To test the performance, input 602 is fed into models 610 and 620. The predicted output 615 and correction 625 generated by the models is fed into decision module 640 which in turn analyzes the two inputs to generate predicted output 645. The deviation is defined as the deviation of the predicted output 645 from output 604 (a.k.a. ground truth). ML model stacker 600 may in turn check the dependence between input 602 and the generated deviation to determine whether there are deterministic relations yet to be captured in the stacked ML model of models 610 and 620. For example, ML model stacker may calculate the stochastic dependence or mutual information between input 602 and the generated deviation. If there is high stochastic dependence, then there are still deterministic relations to be captured. If there are still deterministic relations not yet captured, the process can repeat iteratively, as shown here with the addition of model 630. Once all deterministic relations have been captured, ML model stacker 600 returns stacked ML model 660, which in this example includes models 610, 620, and 630.

For example, let's assume that an output variable from the ML model is nominal data representing types of fruit and the value can be set to classes “apples,” “oranges,” and “bananas.” An integer value may be assigned to each class so “apples”=1, “oranges”=2, and “bananas”=3. The integer value may be assigned by ML model stacker 600 or may be assigned as the dataset was prepared to be stored in the data warehouse. Model 610 may receive input 602 and generate predicted output 615 with a value 1 for apples. The predicted output may in turn be compared with output 604 which is the ground truth which is value 2 for oranges. Residuals may be calculated where the residual is set to a value 0 if the predicted output 615 is correct (i.e., matches the ground truth) and the residual is set to a value representative of the correct class when the predicted output 615 is incorrect (i.e., doesn't match the ground truth). Here, the residual would be set to the value 2. The residuals in turn can be used to train model 620 where the input to model 620 is input 602 and the desired output is the residuals. Once model 620 has been trained, ML model stacker 600 can test the performance of the stacked ML model consisting of model 610 and 620 by inputting input 602 into model 610 and 620 and analyzing their predicted outputs. Here if predicted output 615 of model 610 is the value 1 which is associated with apples and correction 625 is the value 2, then decision module 640 receives the predicted output 615 (i.e. value 1) and correction 625 (i.e. value 2) and generates predicted output 645 as the value 2. This means that the stacked ML model consisting of model 610 and 620 more accurately predicts the output since predicted output 645 is value 2, which is the same as the ground truth.

In another embodiment, supplemental ML models may generate a correction that models the difference between the actual distribution over the classes and the predicted one. This is a multi-dimensional approach where model 610 generates a predicted output 615 that is a distribution over the classes. In one embodiment, the most likely class is the output of a model. In an example, an output variable from the ML model is nominal data representing types of fruit and the value can be set to classes “apples,” “oranges,” and “bananas.” An integer value may be assigned to each class so “apples”=1, “oranges”=2, and “bananas”=3. Model 610 may generate a predicted output for all entries in the training dataset as a distribution over possible class labels. A residual distribution can be generated by subtracting the ground truth distribution, e.g., 1 for the right class and 0 for all the other classes, from the predicted outputs distribution. The residual distribution can in turn be used to train model 620 where the input is input 602 and the output is the residual distribution. The performance of stacked ML model consisting of model 610 and 620 is then tested. If model 620 was properly trained, then correction 625 generated by model 620 may be a correction distribution that when added to predicted output distribution of predicted output 615, shall resemble the ground truth distribution. Decision module 640 may be configured to sum predicted output 615 and correction 625.

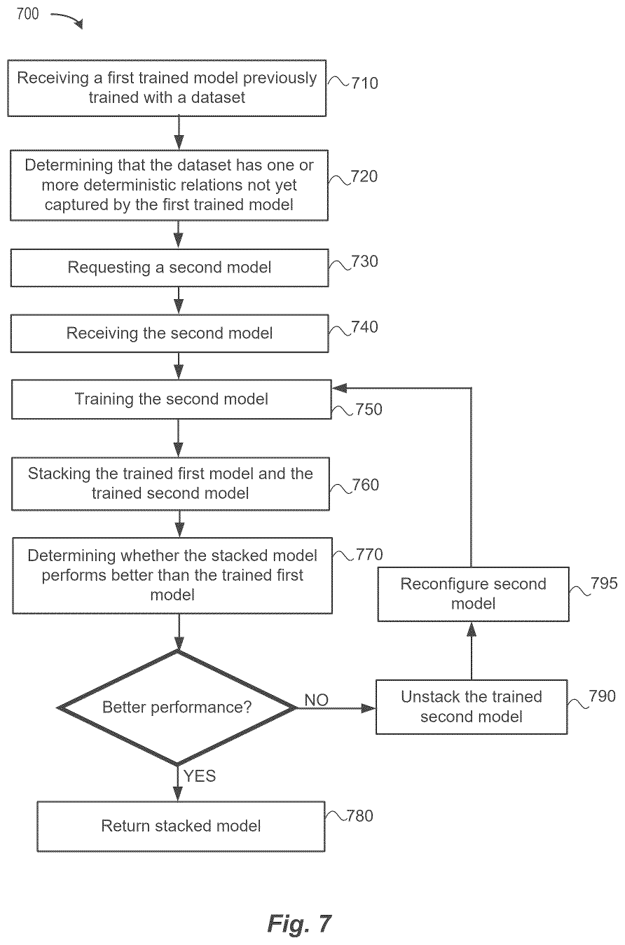

FIG. 7 illustrates an exemplary workflow for training a ML model according to some embodiments. Workflow 700 can be implemented as computer readable code that is stored in model training 230 of FIG. 2 and ML model stacker 260 of FIG. 2, the code being executable by one or more processors from processors 120 of FIG. 1. Workflow 700 can begin by receiving a first trained machine learning model at 710. The first machine learning model may have been previously trained to capture a plurality of deterministic relations within a training dataset. The training dataset may include a plurality of entries, each entry including a plurality of input variables and a plurality of output variables. In one example, the first trained ML model is received from data warehouse 110 of FIG. 1. Depending on the implementation, the dataset can be any dataset that the user plans on using to train a ML model. Workflow 700 continues by determining that the training dataset has one or more deterministic relations not yet captured by the first trained ML model at step 720. In one embodiment, workflow 700 may generate residuals by comparing the predicted output of the first trained model against the ground truth. Stochastic dependence between the input data from the training dataset and the residuals shall identify whether there are deterministic relations not yet captured by the first trained ML model. If there are more deterministic relations, then workflow 700 continues by requesting a second ML model at 730 and receiving the second ML model at 740. In other embodiments, the second ML model may be automatically selected and configured by ML model stacker. Once the second model has been received, workflow 700 continues by training the second ML model at 750. Training the second ML model may include training the second ML model with input data from the training dataset and deviations between the model output and ground truth generated from the first ML model. The goal would be for the corrections generated by second ML model to supplement the predicted output from the first ML model so that the adapted output is closer to the ground truth.

Workflow 700 then continues by stacking the trained first ML model and the trained second ML model at 760. Workflow 700 then continues by determining whether the stacked ML model performs better than the trained first ML model alone at 770. In one embodiment, performance is measured as whether the stacked ML model is able to capture more deterministic relations than the first trained ML model alone. In another embodiment, performance is measured as whether the stacked ML model is able to capture at least one deterministic relation that wasn't captured by the first ML model. In another embodiment, performance is measured by lowering stochastic dependence between input variables and the deviation between the model output and the ground truth. Workflow 700 continues by returning the stacked ML model at step 780 when there is better performance. If there isn't better performance, then workflow 700 continues by unstacking the trained second ML model at 790 and reconfiguring the second ML model at 795. Reconfiguration of the second ML model can include one or more of hyperparameter tuning, selecting a different loss function, or selecting a different ML architecture altogether. Workflow 700 may then continue by retraining the reconfigured second model at 750 and the process may continue. In some embodiments, workflow 700 may iteratively repeat the process of receiving, training, and stacking supplemental ML models until all of the deterministic relations in the training dataset have been captured.

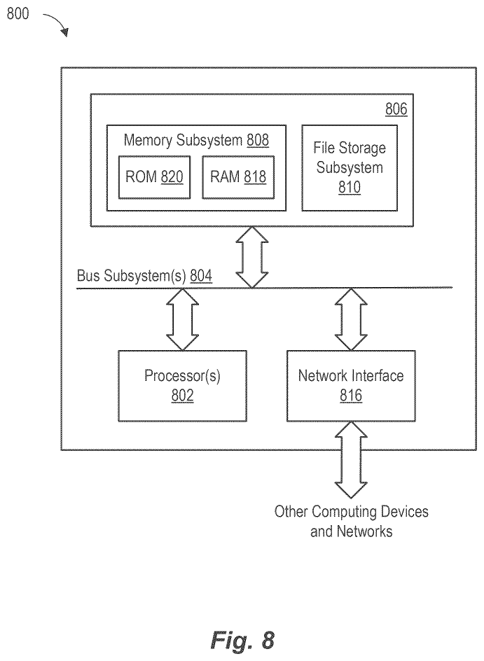

FIG. 8 depicts a simplified block diagram of an example computer system, which can be used to implement some of the techniques described in the foregoing disclosure. As shown in FIG. 8, system 800 includes one or more processors 802 that communicate with several devices via one or more bus subsystems 804. These devices may include a storage subsystem 806 (e.g., comprising a memory subsystem 808 and a file storage subsystem 810) and a network interface subsystem 816. Some systems may further include user interface input devices and/or user interface output devices (not shown).

Bus subsystem 804 can provide a mechanism for letting the various components and subsystems of system 800 communicate with each other as intended. Although bus subsystem 804 is shown schematically as a single bus, alternative embodiments of the bus subsystem can utilize multiple buses.

Network interface subsystem 816 can serve as an interface for communicating data between system 800 and other computer systems or networks. Embodiments of network interface subsystem 816 can include, e.g., Ethernet, a Wi-Fi and/or cellular adapter, a modem (telephone, satellite, cable, etc.), and/or the like.

Storage subsystem 806 includes a memory subsystem 808 and a file/disk storage subsystem 810. Subsystems 808 and 810 as well as other memories described herein are examples of non-transitory computer-readable storage media that can store executable program code and/or data that provide the functionality of embodiments of the present disclosure.

Memory subsystem 808 comprise one or more memories including a main random access memory (RAM) 818 for storage of instructions and data during program execution and a read-only memory (ROM) 820 in which fixed instructions are stored. File storage subsystem 810 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 800 is illustrative and many other configurations having more or fewer components than system 800 are possible.

The above description illustrates various embodiments of the present invention along with examples of how aspects of the present invention may be implemented. The above examples and embodiments should not be deemed to be the only embodiments and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

### FURTHER EXAMPLES

Each of the following non-limiting features in the following examples may stand on its own or may be combined in various permutations or combinations with one or more of the other features in the examples below. In various embodiments, the present disclosure may be implemented as a processor or method.

In some embodiments the present disclosure includes a method, comprising: receiving a first trained machine learning model, the first machine learning model having been previously trained to capture a plurality of deterministic relations within a training dataset containing a plurality of entries, each entry including a plurality of input variables and a plurality of output variables; determining that the training dataset has one or more additional deterministic relations not yet captured by the first machine learning model; requesting a second machine learning model in response to the determination; receiving the second machine learning model in response to the request; training the second machine learning model to capture the one or more additional deterministic relations not yet captured; stacking the trained first machine learning model and the trained second machine learning model to form a stacked machine learning model; determining whether the stacked machine learning model has captured more deterministic relations in the training dataset than the first trained machine learning model; and returning the stacked machine learning model when the stacked machine learning model has captured more deterministic relations in the training dataset than the first trained machine learning model.

In one embodiment determining that the training dataset has one or more additional deterministic relations not yet captured by the first machine learning model comprises: for each entry in the training dataset: providing the plurality of input variables as input to the first machine learning model to generate a plurality of predicted outputs, each of the plurality of predicted outputs associated with one of the plurality of output variables from the training dataset; and generating a plurality of first deviations, each first deviation generated by comparing one of the plurality of predicted outputs and its associated output variable; and determining that there is stochastic dependence between the plurality of input variables in the training dataset and the plurality of first deviations.

In one embodiment, the plurality of first deviations models the difference between the actual distribution over classes and the plurality of predicted outputs given the plurality of input variables.

In one embodiment, generating the plurality of first deviations includes calculating the difference between an output variable and the predicted output associated with the output variable when the output variable is ordinal data or continuous data.

In one embodiment, generating the plurality of first deviations includes setting the deviation to a value zero when output variable is nominal data and the predicted output associated with the output variable accurately predicts the output variable.

In one embodiment, generating the plurality of first deviations includes setting the first deviation to a value representative of the output variable when the output variable is nominal data and the predicted output associated with the output variable inaccurately predicts the output variable.

In one embodiment, wherein training the second machine learning model comprises applying the plurality of input variables from the training dataset as input to the second machine learning model and applying the plurality of first deviations as output to the second machine learning model.

In some embodiments, a system comprises one or more processors; a non-transitory computer-readable medium storing a program executable by the one or more processors, the program comprising sets of instructions for: receiving a first trained machine learning model, the first machine learning model having been previously trained to capture a plurality of deterministic relations within a training dataset containing a plurality of entries, each entry including a plurality of input variables and a plurality of output variables; determining that the training dataset has one or more additional deterministic relations not yet captured by the first machine learning model; requesting a second machine learning model in response to the determination; receiving the second machine learning model in response to the request; training the second machine learning model to capture the one or more additional deterministic relations not yet captured; stacking the trained first machine learning model and the trained second machine learning model to form a stacked machine learning model; determining whether the stacked machine learning model has captured more deterministic relations in the training dataset than the first trained machine learning model; and returning the stacked machine learning model when the stacked machine learning model has captured more deterministic relations in the training dataset than the first trained machine learning model.

In some embodiments, a non-transitory computer-readable medium stores a program executable by one or more processors, the program comprising sets of instructions for receiving a first trained machine learning model, the first machine learning model having been previously trained to capture a plurality of deterministic relations within a training dataset containing a plurality of entries, each entry including a plurality of input variables and a plurality of output variables; determining that the training dataset has one or more additional deterministic relations not yet captured by the first machine learning model; requesting a second machine learning model in response to the determination; receiving the second machine learning model in response to the request; training the second machine learning model to capture the one or more additional deterministic relations not yet captured; stacking the trained first machine learning model and the trained second machine learning model to form a stacked machine learning model; determining whether the stacked machine learning model has captured more deterministic relations in the training dataset than the first trained machine learning model; and returning the stacked machine learning model when the stacked machine learning model has captured more deterministic relations in the training dataset than the first trained machine learning model.

What is claimed is:

1. A method, comprising:
receiving a first trained machine learning model, the first machine learning model having been previously trained to capture a plurality of deterministic relations within a training dataset containing a plurality of entries, each entry including a plurality of input variables and a plurality of output variables;
determining that the training dataset has one or more additional deterministic relations not yet captured by the first machine learning model;
requesting a second machine learning model in response to the determination;
receiving the second machine learning model in response to the request;
training the second machine learning model to capture the one or more additional deterministic relations not yet captured;
stacking the trained first machine learning model and the trained second machine learning model to form a stacked machine learning model;
determining whether the stacked machine learning model has captured more deterministic relations in the training dataset than the first trained machine learning model; and
returning the stacked machine learning model when the stacked machine learning model has captured more deterministic relations in the training dataset than the first trained machine learning model.

2. The method as in claim 1, wherein determining that the training dataset has one or more additional deterministic relations not yet captured by the first machine learning model comprises:
for each entry in the training dataset:
providing the plurality of input variables as input to the first machine learning model to generate a plurality of predicted outputs, each of the plurality of predicted outputs associated with one of the plurality of output variables from the training dataset; and
generating a plurality of first deviations, each first deviation generated by comparing one of the plurality of predicted outputs and its associated output variable; and
determining that there is stochastic dependence between the plurality of input variables in the training dataset and the plurality of first deviations.

3. The method as in claim 2, wherein the plurality of first deviations models the difference between the actual distribution over classes and the plurality of predicted outputs given the plurality of input variables.

4. The method as in claim 2, wherein generating the plurality of first deviations includes calculating the difference between an output variable and the predicted output associated with the output variable when the output variable is ordinal data or continuous data.

5. The method as in claim 2, wherein generating the plurality of first deviations includes setting the deviation to a value zero when output variable is nominal data and the predicted output associated with the output variable accurately predicts the output variable.

6. The method as in claim 2, wherein generating the plurality of first deviations includes setting the first deviation to a value representative of the output variable when the output variable is nominal data and the predicted output associated with the output variable inaccurately predicts the output variable.

7. The method as in claim 2, wherein training the second machine learning model comprises applying the plurality of input variables from the training dataset as input to the second machine learning model and applying the plurality of first deviations as output to the second machine learning model.

8. A system comprising:
one or more processors;
a non-transitory computer-readable medium storing a program executable by the one or more processors, the program comprising sets of instructions for:
receiving a first trained machine learning model, the first machine learning model having been previously trained to capture a plurality of deterministic relations within a training dataset containing a plurality of entries, each entry including a plurality of input variables and a plurality of output variables;
determining that the training dataset has one or more additional deterministic relations not yet captured by the first machine learning model;
requesting a second machine learning model in response to the determination;
receiving the second machine learning model in response to the request;
training the second machine learning model to capture the one or more additional deterministic relations not yet captured;
stacking the trained first machine learning model and the trained second machine learning model to form a stacked machine learning model;
determining whether the stacked machine learning model has captured more deterministic relations in the training dataset than the first trained machine learning model; and
returning the stacked machine learning model when the stacked machine learning model has captured more deterministic relations in the training dataset than the first trained machine learning model.

9. The system of claim 8, wherein determining that the training dataset has one or more additional deterministic relations not yet captured by the first machine learning model comprises:
for each entry in the training dataset:
providing the plurality of input variables as input to the first machine learning model to generate a plurality of predicted outputs, each of the plurality of predicted outputs associated with one of the plurality of output variables from the training dataset; and
generating a plurality of first deviations, each first deviation generated by comparing one of the plurality of predicted outputs and its associated output variable; and
determining that there is stochastic dependence between the plurality of input variables in the training dataset and the plurality of first deviations.

10. The system of claim 9, wherein the plurality of first deviations models the difference between the actual distribution of classes and the plurality of predicted outputs given the plurality of input variables.

11. The system of claim 9, wherein generating the plurality of first deviations includes calculating the difference between a output variable and the predicted output associated with the output variable when the output variable is ordinal data or continuous data.

12. The system of claim 9, wherein generating the plurality of first deviations includes setting the deviation to a value zero when output variable is nominal data and the predicted output associated with the output variable accurately predicts the output variable.

13. The system of claim 9, wherein generating the plurality of first deviations includes setting the first deviation to a value representative of the output variable when the output variable is nominal data and the predicted output associated with the output variable inaccurately predicts the output variable.

14. The system of claim 9, wherein training the second machine learning model comprises applying the plurality of input variables from the training dataset as input to the second machine learning model and applying the plurality of first deviations as output to the second machine learning model.

15. A non-transitory computer-readable medium storing a program executable by one or more processors, the program comprising sets of instructions for:
receiving a first trained machine learning model, the first machine learning model having been previously trained to capture a plurality of deterministic relations within a training dataset containing a plurality of entries, each entry including a plurality of input variables and a plurality of output variables;
determining that the training dataset has one or more additional deterministic relations not yet captured by the first machine learning model;
requesting a second machine learning model in response to the determination;
receiving the second machine learning model in response to the request;
training the second machine learning model to capture the one or more additional deterministic relations not yet captured;
stacking the trained first machine learning model and the trained second machine learning model to form a stacked machine learning model;
determining whether the stacked machine learning model has captured more deterministic relations in the training dataset than the first trained machine learning model; and
returning the stacked machine learning model when the stacked machine learning model has captured more deterministic relations in the training dataset than the first trained machine learning model.

16. The non-transitory computer-readable medium of claim 15, wherein determining that the training dataset has one or more additional deterministic relations not yet captured by the first machine learning model comprises:
for each entry in the training dataset:
providing the plurality of input variables as input to the first machine learning model to generate a plurality of predicted outputs, each of the plurality of predicted outputs associated with one of the plurality of output variables from the training dataset; and
generating a plurality of first deviations, each first deviation generated by comparing one of the plurality of predicted outputs and its associated output variable; and
determining that there is stochastic dependence between the plurality of input variables in the training dataset and the plurality of first deviations.

17. The non-transitory computer-readable medium of claim 16, wherein the plurality of first deviations models the difference between the actual distribution of classes and the plurality of predicted outputs given the plurality of input variables.

18. The non-transitory computer-readable medium of claim 16, wherein generating the plurality of first deviations includes calculating the difference between an output variable and the predicted output associated with the output variable when the output variable is ordinal or continuous data.

19. The non-transitory computer-readable medium of claim 16, wherein generating the plurality of first deviations includes setting the deviation to a value zero when output variable is nominal data and the predicted output associated with the output variable accurately predicts the output variable.

20. The non-transitory computer-readable medium of claim 16, wherein generating the plurality of first deviations includes setting the first deviation to a value representative of the output variable when the output variable is nominal data and the predicted output associated with the output variable inaccurately predicts the output variable.
